(19) United States
(12) Patent Application Publication
(10) Pub. No.: US 2015/0098220 A1
(43) Pub. Date: Apr. 9, 2015

(54) Dimming Operation Apparatus and Lighting System

(71) Applicant: Toshiba Lighting & Technology Corporation, Yokosuka-shi (JP)

(72) Inventor: Tomoki Teisho, Yokosuka-shi (JP)

(73) Assignee: Toshiba Lighting & Technology Corporation, Yokosuka-shi (JP)

(21) Appl. No.: 14/340,643

(22) Filed: Jul. 25, 2014

(30) Foreign Application Priority Data
Oct. 7, 2013 (JP) 2013-209924

(51) Int. Cl. H05B 37/02

(52) U.S. Cl. CPC H05B 37/029
USPC 362/233

(57) ABSTRACT

According to one embodiment, a storage part stores light output characteristic patterns each indicating a ratio of a change in a light output to a change in an input dimming level with respect to plural lighting loads. A display control unit causes a display unit to display plural selection parts corresponding to the lighting loads and to display thumbnail images of the light output characteristic patterns of the lighting loads stored in the storage part correspondingly to the selection parts. A setting unit selects the selection part displayed on the display unit and sets the light output characteristic pattern.

### INCORPORATION BY REFERENCE

The present invention claims priority under 35 U.S.C. §119 to Japanese Patent Application No. 2013-209924 filed on Oct. 7, 2013. The content of the application is incorporated herein by reference in their entirety.

### FIELD

Embodiments described herein relate generally to a dimming operation apparatus for setting light output characteristic patterns of lighting loads and to a lighting system.

### BACKGROUND

Hitherto, for example, in lighting for a studio or a stage, a dimming operation console is used as a dimming operation apparatus for controlling dimming states of plural lighting loads installed in the studio or the stage. This dimming operation console includes plural feeders, and input dimming levels are changed by operation of the respective feeders, so that light outputs of the lighting loads previously assigned to the respective feeders are changed.

In the dimming operation console, based on light output characteristic patterns (profile curves) previously set for the respective lighting loads, the light outputs of the lighting loads are changed with respect to the input dimming levels operated by the feeders. The light output characteristic pattern is for setting the ratio of the change in light output of the lighting load to the change in input dimming level by the operation of the feeder, and can be arbitrarily set.

When the already set light output characteristic pattern of the lighting load is confirmed, or is corrected and set, a setting screen including plural selection parts corresponding to the plural lighting loads is displayed by a display unit of the dimming operation console, and an arbitrary selection part is selected on the setting screen, so that the light output characteristic pattern of the lighting load corresponding to the selected selection part is displayed. The displayed light output characteristic pattern is confirmed, and is corrected and set if necessary.

However, although the plural selection parts corresponding to the plural lighting loads are displayed on the setting screen displayed by the display unit of the dimming operation console, it is not apparent what light output characteristic patterns are set for the respective selection parts. Accordingly, the confirmation must be performed in such a way that the plural selections parts are selected one by one, and the light output characteristic patterns of the lighting loads are displayed one by one. This takes labor and time, and has a problem in operation efficiency.

Exemplary embodiments described herein provide a dimming operation apparatus capable of improving operation efficiency and a lighting system.

### BRIEF DESCRIPTION OF THE DRAWINGS

FIG. 1 is a front view of a light output characteristic pattern setting screen displayed on a display unit of a dimming operation apparatus of an embodiment.

FIG. 2 is a block diagram of a lighting system using the dimming operation apparatus.

FIG. 3 is a flowchart of displaying a thumbnail image of the dimming operation apparatus.

FIG. 4 is a front view of an assignment setting screen displayed by the display unit of the dimming operation apparatus.

### DETAILED DESCRIPTION

In general, according to one embodiment, a dimming operation apparatus includes a storage part, a display unit, a display control unit and a setting unit. The storage part stores light output characteristic patterns each indicating a ratio of a change in a light output to a change in an input dimming level with respect to plural lighting loads. The display unit displays an image. The display control unit causes the display unit to display plural selection parts corresponding to the lighting loads and to display thumbnail images of the light output characteristic patterns of the lighting loads stored in the storage part correspondingly to the selection parts. The setting unit selects the selection part displayed on the display unit and sets the light output characteristic pattern.

According to the embodiment, even if the selection part displayed on the display unit is not selected, the light output characteristic pattern of the lighting load can be confirmed by the thumbnail image displayed correspondingly to the selection part, and the improvement of operation efficiency can be expected.

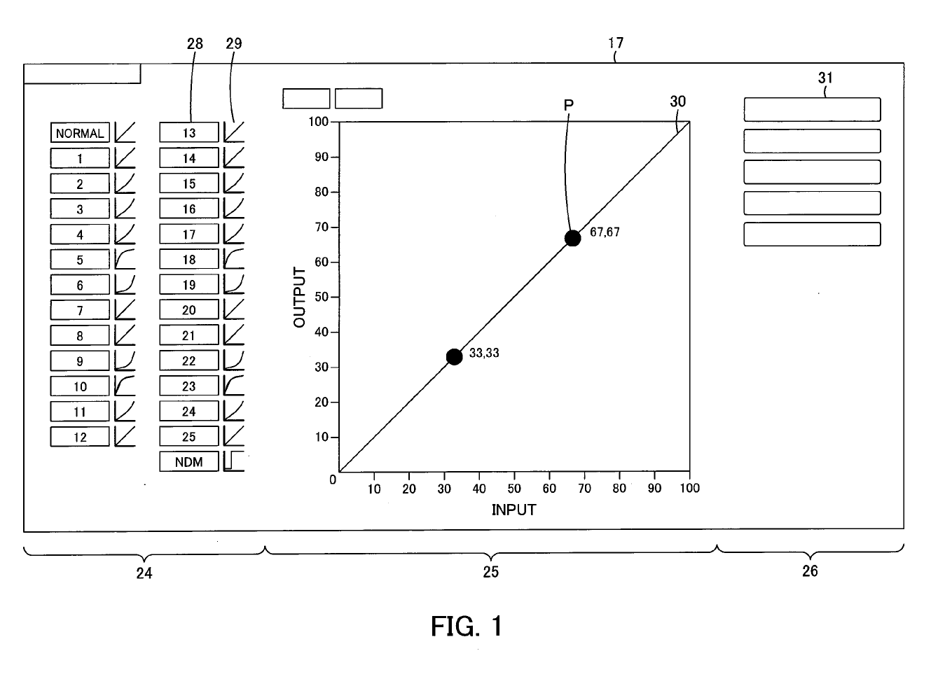

Hereinafter, an embodiment will be described with reference to FIG. 1 to FIG. 4.

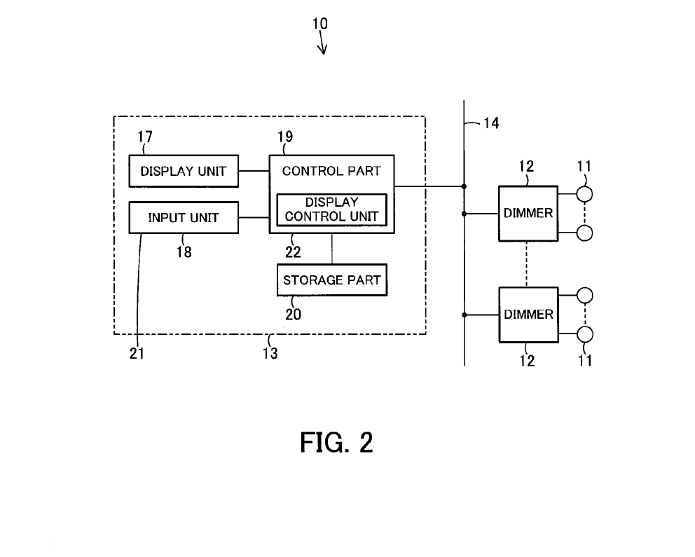

FIG. 2 shows a lighting system 10 used for lighting of a studio or a stage. The lighting system 10 controls dimming states of plural lighting loads (lighting apparatus) 11 installed in the studio or the stage according to a performance scene or the like.

The lighting system 10 includes plural dimmers 12 to dim and control the plural lighting loads 11, and a dimming operation apparatus 13 to operate input dimming levels of the respective lighting loads 11. These can be communicated with each other through a network 14. A communication protocol such as DMX512 is used for the communication.

Each of the dimmers 12 captures dimming data of its own address transmitted from the dimming operation apparatus 13, and dims the lighting load 11 in accordance with the dimming data. Besides, the lighting load 11 includes a light source such as an LED or a lamp, and the dimmer 12 controls the lighting state of the light source.

Besides, the dimming operation apparatus 13 is a dimming operation console and has a function of a circuit control console to perform light output characteristic pattern (profile curve) setting or assignment setting. Incidentally, only the function of the circuit control console may be provided.

The dimming operation apparatus 13 includes a display unit 17, an input unit 18, a control part 19 and a storage part 20.

The display unit 17 is constructed of a display having a flat display surface to display an image. The display is constructed of a liquid crystal display or the like to perform color display.

The input unit 18 includes a touch panel disposed on the front side of the display surface. For example, in the case of an electrostatic capacitance type touch panel, transparent electrodes are arranged in a lattice form in a longitudinal direction and a lateral direction on the panel surface, and a touch position on the panel surface is detected from a change in electrostatic capacitance occurring when a finger of an operator touches. Incidentally, the input unit 18 may include another input equipment such as a mouse or a keyboard. The input unit 18 is constructed as a setting unit 21 to set the light output characteristic pattern.

The control part 19 controls the whole dimming operation apparatus 13. The control part 19 includes a display control unit 22 to cause the display unit 17 to display an image.

The control part 19 can write and read data in and from the storage part 20. The storage part 20 stores the light output characteristic patterns (profile curves) to set the ratio of change in light output to the change in input dimming level with respect to the plural lighting loads 11.

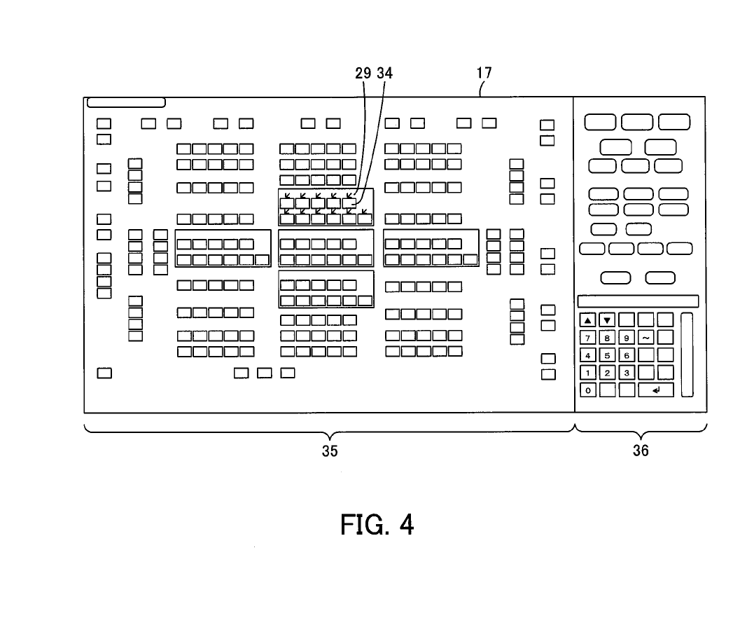

Besides, the display control unit 22 causes the display unit 17 to display an image of a screen such as a light output characteristic pattern setting screen shown in FIG. 1, an assignment setting screen shown in FIG. 4, and a dimming operation screen (not shown) to display feeders and the like.

The light output characteristic pattern setting screen shown in FIG. 1 includes a left selection display area 24, a center pattern display area 25 and a right menu display area 26.

Plural selection parts 28 corresponding to the plural lighting loads 11 are displayed in the selection display area 24. The selection parts 28 are displayed in square button form, and the number corresponding to each of the lighting loads 11 is displayed inside the button. Further, thumbnail images 29 of the light output characteristic patterns of the respective lighting loads 11 stored in the storage part 20 are displayed correspondingly to the selection parts 28. In this embodiment, the plural selection parts 28 are arranged in an up-and-down direction, and are arranged in two lines in a right-and-left direction, and the thumbnail image 29 is displayed on the right side of each of the selection parts 28. The thumbnail image 29 is an image in which a graph of the light output characteristic pattern is contracted.

The graph of the light output characteristic pattern of the lighting load 11 corresponding to the selected selection part 28 is enlarged and displayed in the pattern display area 25. In the graph of the light output characteristic pattern, the horizontal axis indicates a ratio of 0% to 100% in input dimming level, and the vertical axis indicates a ratio of 0% to 100% in light output of the lighting load 11. A value of 0% indicates extinction of the lights, and 100% indicates lighting of all the lights. In the graph, the light output characteristic pattern is represented by a light output characteristic pattern line 30 which is a straight line or a curved line in the range of 0% to 100%.

The light output characteristic pattern is such that the ratio of the change in the light output to the change in the input dimming level is set. For example, like the thumbnail image 29 of the selection part 28 of the number 9, the light output characteristic pattern becomes a curved line in which the ratio of the change in the light output is low in an area in which the input dimming level is close to 0%, and the ratio of the change in the light output is large in an area in which the input dimming level is close to 100%. Besides, like the thumbnail image 29 of the selection part 28 of the number 10, the light output characteristic pattern becomes a curved line in which the ratio of the change in the light output is large in an area in which the input dimming level is close to 0%, and the ratio of the change in the light output is small in an area in which the input dimming level is close to 100%. The light output characteristic pattern of the example shown in the pattern display area 25 of FIG. 1 is the light output characteristic pattern line 30 of a straight line in which the ratio of the change in the input dimming level is equal to the ratio of the change in the light output. Plural adjustment points P exist in the middle of the light output characteristic pattern line 30, and the light output characteristic pattern can be adjusted to an arbitrary light output characteristic pattern by moving the adjustment points P by the input unit 18.

Plural menu display parts 31 corresponding to plural menu items including setting items of the light output characteristic pattern are displayed in the menu display area 26.

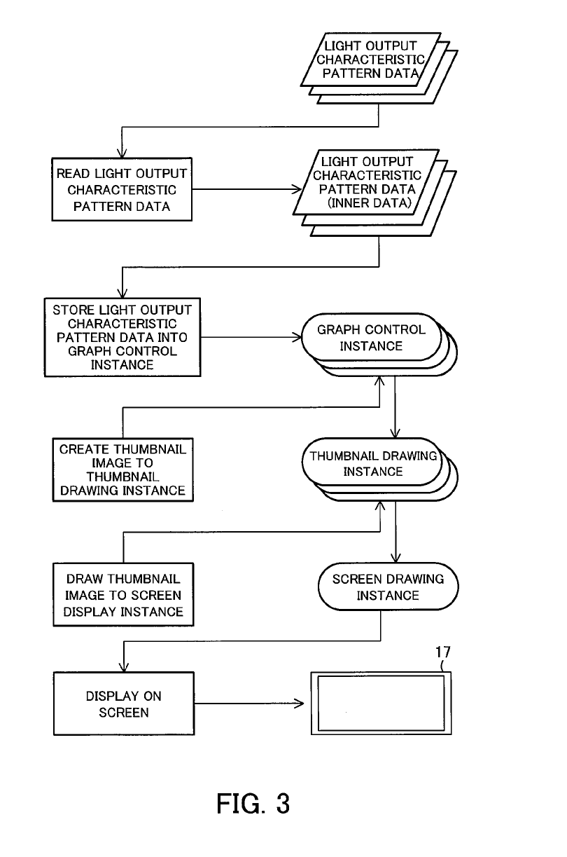

FIG. 3 shows a flowchart of displaying the thumbnail images 29 by the display control unit 22.

When the thumbnail images 29 of the light output characteristic patterns are displayed, all the light output characteristic pattern data are read from the storage part 20, and the read light output characteristic pattern data are stored in a graph control instance.

The thumbnail images are created in a thumbnail drawing instance based on the light output characteristic pattern data stored in the graph control instance.

The thumbnail images created in the thumbnail drawing instance are drawn in a screen drawing instance.

The contents drawn in the screen drawing instance are displayed on the screen of the display unit 17.

As shown in FIG. 1, in order to set the light output characteristic patterns, the light output characteristic pattern setting screen is displayed on the display unit 17, so that the plural selection parts 28 corresponding to the plural lighting loads 11 are displayed, and the thumbnail images 29 of the light output characteristic patterns of the lighting loads 11 are displayed correspondingly to the selection parts 28. Thus, the light output characteristic patterns of the respective lighting loads 11 can be confirmed by the thumbnail images 29.

When the light output characteristic pattern is corrected, the selection part 28 is selected, and the graph of the light output characteristic pattern of the lighting load 11 corresponding to the selected selection part 28 is enlarged and displayed. The light output characteristic pattern can be corrected to an arbitrary light output characteristic pattern by moving the the adjustment point P of the light output characteristic pattern line 30 by the input unit 18. The corrected light output characteristic pattern is renewed and stored in the storage part 20.

When the light output characteristic pattern displayed in the pattern display area 25 is corrected, the corresponding thumbnail image 29 is also renewed to the thumbnail image 29 after the correction.

As described above, in the dimming operation apparatus 13, even if the light output characteristic pattern is not displayed in the pattern display area 25 by selecting the selection part 28 displayed on the display unit 17, the light output characteristic pattern of the lighting load 11 can be confirmed by the thumbnail image 29 displayed correspondingly to the selection part 28. Accordingly, as compared with the case where the selection part 28 is selected and the light output characteristic pattern is displayed in the pattern display area 25 one by one to confirm, labor and time are not required, and operation efficiency can be improved.

Further, the selection display area 24 for displaying the selection parts 28 and the thumbnail images 29, and the pattern display area 25 for displaying the light output characteristic pattern of the lighting load 11 selected by the selection part 28 are simultaneously displayed on the display unit 17. Accordingly, while the light output characteristic patterns of all the lighting loads 11 are grasped by the selection parts 28 and the thumbnail images 29 displayed in the selection display area 24, the selection part 28 is selected and the light output characteristic pattern of the lighting load 11 displayed in the pattern display area 25 can be corrected and set, and the operation efficiency can be improved.

Besides, the assignment setting screen shown in FIG. 4 includes a layout display area 35 for arranging and displaying plural selection parts 34 which can be selected correspondingly to the layout of the plural lighting loads 11 installed in a studio, and an operation display area 36 for performing various operations such as selection of feeders to be assigned and switching of screens.

In the assignment operation, the feeder to be assigned in the operation display area 36 is selected, and the lighting load 11 assigned to the feeder is assigned by selecting one or plural selection parts 34 of the layout display area 35.

In the assignment setting screen, the thumbnail images 29 of the light output characteristic patterns may be displayed correspondingly to the selection parts 34. The thumbnail images 29 may be displayed correspondingly to all the selection parts 34. Alternatively, a previously determined group area is selected and the thumbnail images may be displayed correspondingly to the plural selection parts 34 included in the group area, or the thumbnail image may be displayed correspondingly to only the selected selection part 34.

Also in the assignment operation, a graph of a light output characteristic pattern as in the pattern display area 25 of the light output characteristic pattern setting screen of FIG. 1 is displayed and the light output characteristic pattern may be corrected by selecting an item of the light output characteristic pattern in the operation display area 36 and by selecting the selection part 34.

At the time of dimming operation, the feeder or the like is displayed on the dimming operation screen of the display unit 17, and the feeder is operated by the input unit 18, so that the light output of the lighting load 11 is changed with respect to the input dimming level operated by the feeder based on the light output characteristic pattern previously set for each of the lighting loads 11.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A dimming operation apparatus comprising:
a storage part to store light output characteristic patterns each indicating a ratio of a change in a light output to a change in an input dimming level with respect to a plurality of lighting loads;
a display unit to display an image;
a display control unit that causes the display unit to display a plurality of selection parts corresponding to the lighting loads and to display thumbnail images of the light output characteristic patterns of the lighting loads stored in the storage part correspondingly to the selection parts; and
a setting unit that selects the selection part displayed on the display unit and sets the light output characteristic pattern.

2. The apparatus according to claim 1, wherein the display control unit causes the display unit to simultaneously display a selection display area for displaying the selection parts and the thumbnail images, and a pattern display area for displaying the light output characteristic pattern of the lighting load selected by the selection part.

3. The apparatus according to claim 2, wherein the display control unit causes the selection display area to be displayed at a side part of the display unit and causes the pattern display area to be displayed at a center of the display unit.

4. The apparatus according to claim 1, wherein the display control unit causes the display unit to display the selection parts and the thumbnail images side by side.

5. The apparatus according to claim 4, wherein the display control unit causes the display unit to display the plurality of selection parts side by side in a longitudinal direction, and to display the plurality of thumbnail images and the selection parts side by side in a lateral direction.

6. The apparatus according to claim 1, wherein
the storage part renews and stores the light output characteristic pattern set by the setting unit, and
the display control unit renews the thumbnail image displayed by the display unit according to renewal of the light output characteristic pattern stored in the storage part.

7. The apparatus according to claim 1, wherein
the display control unit causes a plurality of adjustment points to be displayed on the light output characteristic pattern displayed in the pattern display area of the display unit, and
the setting unit sets the light output characteristic pattern by moving the adjustment points.

8. The apparatus according to claim 1, wherein the display control unit causes the display unit to display the selection parts correspondingly to a layout in which the lighting loads are installed.

9. The apparatus according to claim 1, further comprising:
an input unit to input the input dimming level; and
a control part to output dimming data to cause the light output of the lighting load to become the light output corresponding to the change in the input dimming level inputted by the input unit based on the light output characteristic pattern of the lighting load stored in the storage part.

10. A lighting system comprising:
a plurality of lighting loads;
a dimmer to input dimming data and to dim and control the lighting loads; and
a dimming operation apparatus to output the dimming data to the dimmer, wherein
the dimming operation apparatus includes:
a storage part to store light output characteristic patterns each indicating a ratio of a change in a light output to a change in an input dimming level with respect to the lighting loads;
a display unit to display an image;
a display control unit that causes the display unit to display a plurality of selection parts corresponding to the lighting loads and to display thumbnail images of the light output characteristic patterns of the lighting loads stored in the storage part correspondingly to the selection parts; and
a setting unit that selects the selection part displayed on the display unit and sets the light output characteristic pattern.

11. The system according to claim 10, wherein the display control unit causes the display unit to simultaneously display a selection display area for displaying the selection parts and the thumbnail images, and a pattern display area for displaying the light output characteristic pattern of the lighting load selected by the selection part.

12. The system according to claim 11, wherein the display control unit causes the selection display area to be displayed at a side part of the display unit and causes the pattern display area to be displayed at a center of the display unit.

13. The system according to claim 10, wherein the display control unit causes the display unit to display the selection parts and the thumbnail images side by side.

14. The system according to claim 13, wherein the display control unit causes the display unit to display the plurality of selection parts side by side in a longitudinal direction, and to display the plurality of thumbnail images and the selection parts side by side in a lateral direction.

15. The system according to claim 10, wherein
the storage part renews and stores the light output characteristic pattern set by the setting unit, and
the display control unit renews the thumbnail image displayed by the display unit according to renewal of the light output characteristic pattern stored in the storage part.

16. The system according to claim 10, wherein
the display control unit causes a plurality of adjustment points to be displayed on the light output characteristic pattern displayed in the pattern display area of the display unit, and
the setting unit sets the light output characteristic pattern by moving the adjustment points.

17. The system according to claim 10, wherein the display control unit causes the display unit to display the selection parts correspondingly to a layout in which the lighting loads are installed.

18. The system according to claim 10 wherein the dimming operation apparatus, further includes:
an input unit to input the input dimming level; and
a control part to output dimming data to cause the light output of the lighting load to become the light output corresponding to the change in the input dimming level inputted by the input unit based on the light output characteristic pattern of the lighting load stored in the storage part.
